(19) United States
(12) Patent Application Publication
(10) Pub. No.: US 2011/0211127 A1
(43) Pub. Date: Sep. 1, 2011

(54) DISPLAY APPARATUS AND DISPLAY METHOD

(75) Inventor: Song Kaiwen Kelvin, Ome-shi (JP)

(73) Assignee: KABUSHIKI KAISHA TOSHIBA, Tokyo (JP)

(21) Appl. No.: 13/036,960

(22) Filed: Feb. 28, 2011

(30) Foreign Application Priority Data
Feb. 26, 2010 (JP) 2010-042896

(51) Int. Cl. H04N 5/57

(52) U.S. Cl. 348/687; 348/E05.119

(57) ABSTRACT

According to one embodiment, a display method includes generating data includes pixels, each pixel of the data having brightness values corresponding to reference colors, selecting a first correction data, which corresponds to a first luminance level dimmer than a second luminance level and comprises correction information items corresponding to the brightness values of the data, and a second correction data which corresponds to the second luminance level and comprises correction information items corresponding to the brightness values, and correcting the brightness values of each pixel of the data based on the selected correction data, wherein a second brightness value obtained by correcting a first brightness value based on the first correction data is higher than a third brightness value obtained by correcting the first brightness value based on the second correction data, and the first brightness value is equal to neither the minimum nor the maximum brightness value.

### CROSS-REFERENCE TO RELATED APPLICATIONS

This application is based upon and claims the benefit of priority from Japanese Patent Application No. 2010-042896, filed Feb. 26, 2010, the entire contents of which are incorporated herein by reference.

### FIELD

Embodiments described herein relate generally to a display apparatus, which displays a video image, and to a display method.

### BACKGROUND

When a notebook personal computer is driven by a battery, the luminance of a display apparatus is reduced in order to elongate a driving time.

The luminance of a display apparatus is reduced, and thereby, a screen becomes dark. Even if the screen becomes dark, there is no disadvantage if user sees letters only on the screen. However, when a moving image such as a DVD-Video is reproduced, if a screen becomes dark, user may find the dark scene of a moving image hard to watch.

The Patent document 1, namely, Jpn. Pat. Appln. KOKAI Publication No. 2004-246099 discloses the following technique. According to the foregoing technique, a quantity of backlight is saved while retaining overall visible brightness on a screen of a display apparatus including backlight and a liquid crystal panel to reduce energy consumption of an image display apparatus.

According to the technique disclosed in the foregoing Patent document 1, a RGB format frame image is converted into a YCbCr format image using a conversion formula, and thereafter, a luminance signal component Y is adjusted. Then, the adjusted YCbCr format image is converted into a RGB format image using a conversion formula. The luminance signal component was adjusted, and therefore, the brightness of RGB of a pixel in the RGB format image is uniformly adjusted.

But, in this case, the color temperature of each gradation is different; for this reason, if the brightness of RGB is uniformly adjusted, the color temperature of a liquid crystal panel changes. As a result, a color shift is generated in a display apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of a display apparatus according to one embodiment.

FIG. 2 is an exemplary block diagram showing the system configuration of the display apparatus shown in FIG. 1.

FIG. 3 is an exemplary table showing energy consumption and battery driving time with respect to a backlight luminance setting value.

FIG. 4 is an exemplary block diagram showing the configuration of a DVD application according to one embodiment.

FIG. 5 is an exemplary view showing data stored in a standard mode setting data, a first economy mode setting data and a second economy mode setting data according to one embodiment.

FIG. 6 is an exemplary graph to explain a luminance of a display panel with respect to a bit value before correction according to one embodiment.

FIG. 7 is an exemplary graph to explain a luminance of a display panel of a frame image corrected based on a gamma correction table stored in a standard mode setting data with respect to a bit value before correction according to one embodiment.

FIG. 8 is an exemplary graph to explain a luminance of a display panel of a frame image corrected based on a gamma correction table stored in a economy mode setting data with respect to a bit value before correction according to one embodiment.

FIG. 9 is an exemplary graph to explain a bit value corrected by a gamma correction table stored in a first standard mode setting data and a bit value corrected by a gamma correction table stored in a first economy mode setting data with respect to a bit value before correction

FIG. 10 is an exemplary graph to explain a luminance of a display panel of a frame image corrected based on a gamma correction table stored in a standard mode setting data and a luminance of a display panel of a frame image corrected based on a gamma correction table stored in a economy mode setting data with respect to a bit value before correction according to one embodiment.

FIG. 11 is an exemplary graph to explain a lowest luminance visible to human eye of a display panel of a frame image corrected based on a gamma correction table stored in a standard mode setting data and a luminance of a display panel of a frame image corrected based on a gamma correction table stored in a first economy mode setting data with respect to a bit value before correction according to one embodiment.

FIG. 12 is an exemplary flowchart to explain the procedure in which a management unit notifies a mode to a presenter according to one embodiment.

FIG. 13 is an exemplary block diagram showing the system configuration of a presenter according to one embodiment.

FIG. 14 is an exemplary flowchart to explain the procedure of generating a frame image, executing a gamma correction and adjusting an image quality according to one embodiment.

### DETAILED DESCRIPTION

Various embodiments will be described hereinafter with reference to the accompanying drawings.

In general, according to one embodiment, a display apparatus includes a liquid crystal panel, a backlight, a video data generator, a selector, a corrector, and a video signal generator. The liquid crystal panel configured to display a video image, comprising a plurality of cells for controlling quantity of transmitted light based on a video signal. The backlight configured to illuminate the liquid crystal panel using a light having a luminance corresponding to a luminance level. The video data generator configured to generate video data comprising a plurality of pixels, each pixel of the video data having a plurality of brightness values corresponding to three or more reference colors. The selector configured to select a first correction data, which corresponds to a first luminance level dimmer than a second luminance level and comprises a plurality of correction information items corresponding to the plurality of brightness values of the video data, and a second correction data, which corresponds to the second luminance level and comprises a plurality of correction information items corresponding to the plurality of brightness values. The corrector configured to correct the brightness values of each pixel of the video data based on the selected correction data. The video signal generator configured to generate the video signal based on the video data comprising the corrected pixels. The second brightness value obtained by correcting a first brightness value based on the first correction data is higher than a third brightness value obtained by correcting the first brightness value based on the second correction data, and the first brightness value is equal to neither the minimum nor the maximum brightness value.

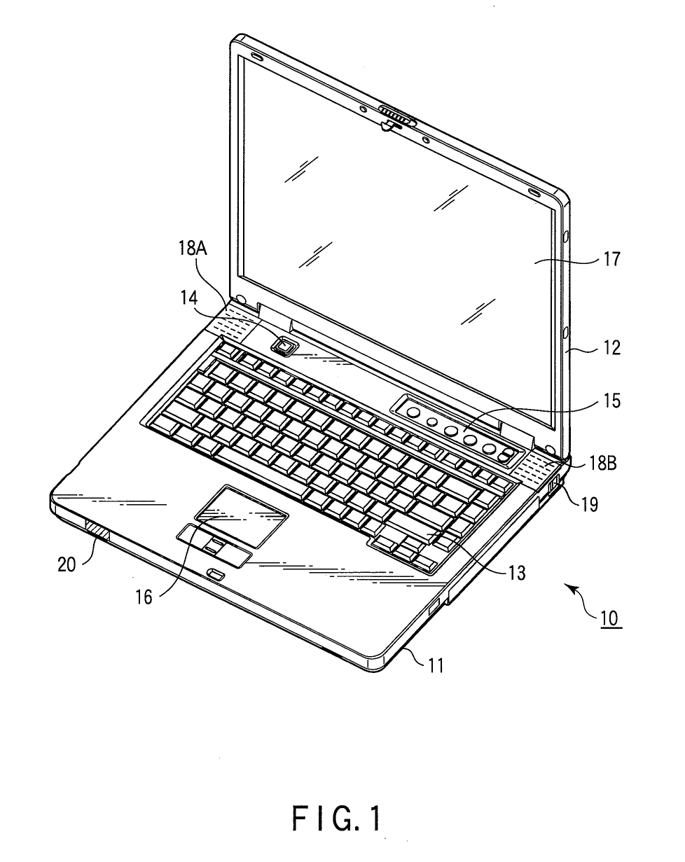

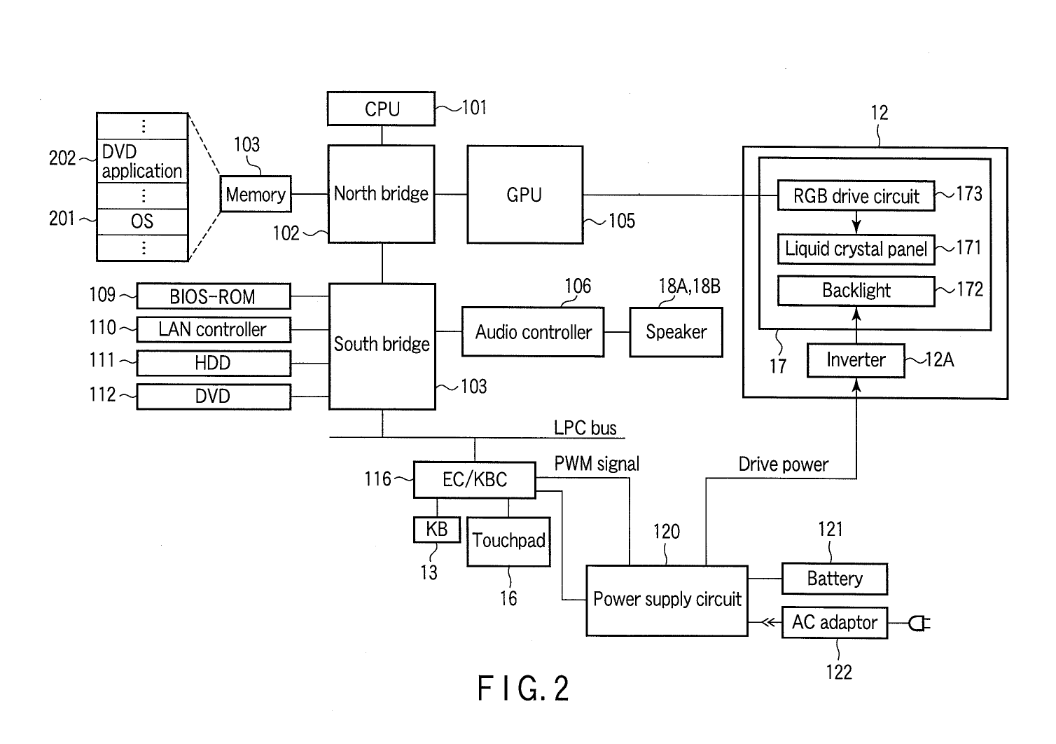

First, the configuration of a display apparatus according to one embodiment will be described with reference to FIGS. 1 and 2. For example, the display apparatus of this embodiment is realized from a notebook and portable personal computer 10 functioning as an information processing apparatus.

The personal computer 10 is able to record and reproduce video content data (audio-visual content data) such as broadcasting program data and video data input from an external device. In other words, the personal computer 10 has a television (TV) function for watching and recording broadcasting program data broadcasted by a television broadcasting signal. For example, the foregoing television TV function is realized by a television (TV) application program previously installed in the personal computer 10. Moreover, the television (TV) function has a function of recording video data input from an external audio-visual (AV) apparatus and a function of reproducing recorded video data and recorded broadcasting program data.

FIG. 1 is a perspective view showing a state that a display unit of the computer 10 is opened. The computer 10 comprises a computer main body 11 and a display unit 12. A display panel 17 having a liquid crystal panel is incorporated into the display unit 12.

The display unit 12 is attached to the computer main body 11 so that it is freely rotatable between the following positions. One is an open position where the upper surface of the computer main body 11 is exposed. The other is a closed position where the display unit 12 covers the upper surface of the computer main body 11. The computer main body 11 has a thin box-shaped housing. The upper surface of the computer main body 11 is provided with a keyboard 13, a power button 14, an input control panel 15, a touchpad 16 and speakers 18A and 18B. The power button 14 turns on/off the power of the computer 10.

The input control panel 15 is an input device for inputting an event corresponding to a pressed button. The panel 15 is provided with a plurality of buttons for starting up each of a plurality of functions. The foregoing button group includes a control button for controlling a television (TV) function (watching, recording, reproducing recorded broadcasting program data/video data).

The system configuration of the computer 10 will be described below with reference to FIG. 2.

As shown in FIG. 2, the computer 10 includes a CPU 101, a north bridge 102, a main memory 103, a south bridge 104, a graphics processing unit (GPU) 105, a video memory (VRAM) 105A, an audio controller 106 and a BIOS-ROM 109. Further, the computer 10 includes a LAN controller 110, a hard disk drive (HDD) 111, a DVD drive 112, an IEEE 1394 controller 115, an embedded controller/keyboard controller IC (EC/KBC) 116, a television (TV) tuner 117 and a power supply circuit 120.

The display unit 12 includes a display panel 17 having a liquid crystal panel 171, a RGB drive circuit 173 and a backlight 172173, and an inverter 12A.

A color filter of the liquid crystal panel 171 is a RGB type having red, green and blue filter segments (cells). The backlight 172 is an illumination unit, which illuminates a backlight liquid crystal panel 171 from the back. The inverter 12A steps up drive power supplied from the power supply circuit 120, and thereafter, supplies the stepped-up power to the backlight 172. In this case, the backlight may be an edge light type or a direct type.

The CPU 101 is a processor, which controls the operation of the computer 10. The CPU 101 executes an operating system (OS) 201 and various application programs such as a DVD application program 202, which are loaded from the hard disk drive (HDD) 111 to the main memory 103. The DVD application program 202 is software for reproducing a DVD loaded into the DVD drive 112. Further, the CPU 101 executes a basic input output system (BIOS) stored in the BIOS-ROM 109. The BIOS is a program for performing software control. The north bridge 102 is a bridge device, which makes a connection between a local bus of the CPU 101 and the south bridge 104.

Further, the north bridge 102 has a built-in memory controller, which controls the access of the main memory 103. Further, the north bridge 102 has a function of performing communication with the GPU 105 by means of a serial bus conforming to the PCI EXPRESS standard.

The GPU 105 is a display controller, which controls a liquid crystal panel 171 used as a display monitor of the computer 10. The GPU 105 uses the VRAM 105A as a work memory. A video signal generated by the GPU 105 is supplied to the liquid crystal panel 171.

Moreover, the GPU 105 is a display controller, which controls red, green and blue pixels of the liquid crystal panel 171 used as a display monitor of the computer 10. The GPU 105 has a video memory (VRAM). The GPU 105 generates a video signal for forming a display image to be displayed on the liquid crystal panel 171 from display data drawn in the video memory by an OS/application program. A video signal given as a control signal generated by the GPU 105 is output to the display panel 17. The RGB drive circuit 173 included in the display panel 17 drives red, green and blue pixels of the liquid crystal panel 171 based on the supplied video signal. Further, the circuit 173 controls a quantity of each transmitted light of red, green and blue pixels.

The south bridge 104 controls each device on a low pin count (LPC) bus and each device on peripheral component interconnect (PCI) bus. Further, the south bridge 104 has a built-in IDE (integrated drive electronics) controller for controlling hard disk drive (HDD) 111 and DVD drive 112. Further, the south bridge 104 has a function of performing a communication with the audio controller 106. The audio controller is an audio source device, and outputs reproduction target audio data to speakers 18A and 18B.

The embedded controller/keyboard controller IC (EC/KBC) 116 is a one-chip microcomputer, which is integrated with an embedded controller for power management, and a keyboard controller for controlling the keyboard (KB) 13 and touchpad 16. The embedded controller/keyboard controller IC (EC/KBC) 116 has a function of turning on/off the power of the computer in accordance with an operation of the power button 14 by user. A power supply circuit 120 generates system power to be supplied to each component of the computer 10 using internal power supplied from a battery 121 or using external power supplied via an AC adaptor 122.

The foregoing EC/KBC 116 generates a PWM signal based on a preset luminance level. The power supply circuit 120 supplies driving power having a voltage based on the PWM signal to the inverter 12A. The inverter 12A supplies stepped-up power to the backlight 172, and thereby, the backlight 172 is lighted at a luminance corresponding to the foregoing luminance level. In this case, a settable luminance is levels 1 to 8, from darkest to the brightest.

An operating system 201 is able to acquire luminance level setting from the BIOS. Moreover, the operating system 201 has a function of notifying a luminance level in accordance with an inquiry from an application program. In this case, the luminance level is stored in a nonvolatile memory included in the EC/KBC 116. Moreover, the luminance level may be stored in the BIOS-ROM 109.

The operating system 201 has a function of recognizing a generation source of a system power for driving the computer 10, and notifying that the generation source is any of internal and external power in accordance with an inquiry from other application program.

Moreover, the operating system 201 has a function of automatically changing the luminance level of the backlight 172 in accordance with power for driving the computer 10. For example, the operating system 201 sets the luminance level of the backlight 172 to a level 8 corresponding to the maximum luminance when the computer 10 is driven by external power. On the other hand, the operating system 201 sets the luminance level of the backlight 172 to a level 1 corresponding to the minimum luminance when the computer 10 is driven by internal power (battery).

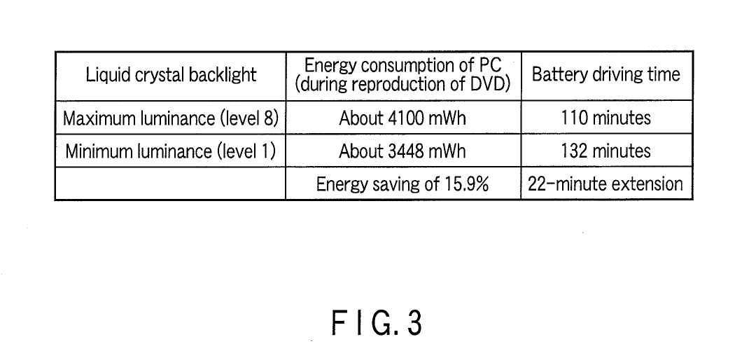

As can be seen from FIG. 3, for example, when DVD-Video is reproduced at the level 8 during battery driving, energy of about 4100 mWh is consumed, and the driving time is 110 minutes. However, when the DVD-Video is reproduced at the level 1 during battery driving, energy of about 3448 mWh is consumed, and the driving time is 123 minutes. Namely, when the computer is driven by the battery, the luminance level of the backlight 172 is automatically changed from the level 8 to the level 1, and thereby, energy consumption is reduced 15.9%. As a result, the battery driving time is extended for 22 minutes.

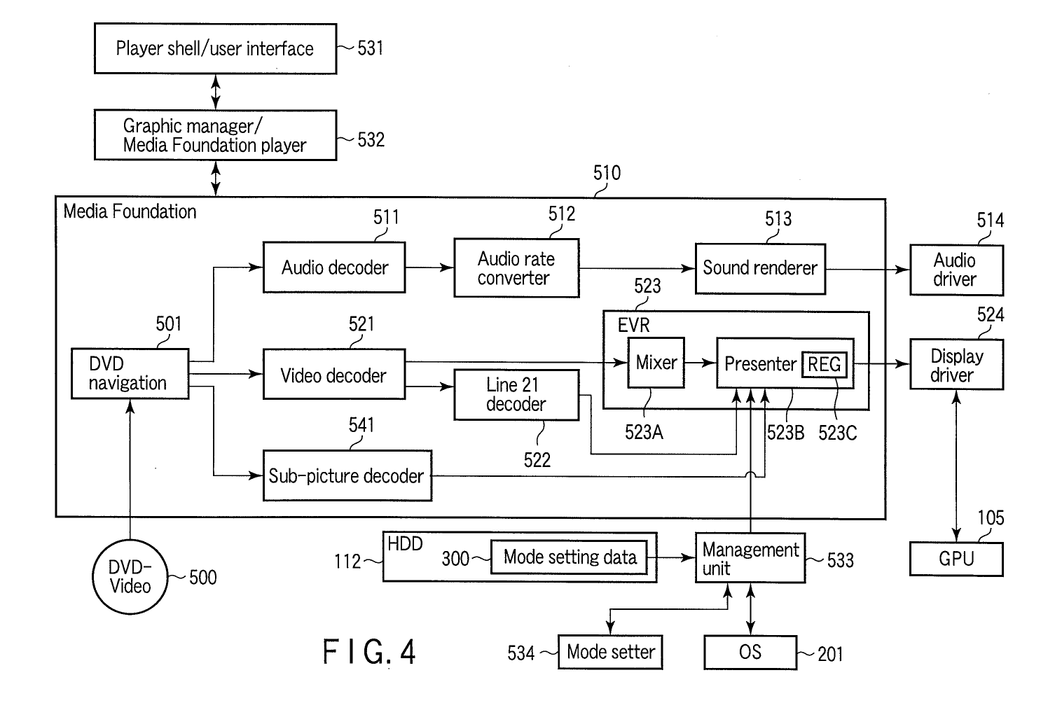

FIG. 4 shows the configuration of a DVD application program 202 executed by the CPU 101 of this apparatus to reproduce contents. A technology called Media Foundation is employed in this player software. Media Foundation is executed under a Windows (registered trademark) environment, which is an operating system (OS) manufactured by Microsoft Corporation, to reproduce content. Media Foundation is a Windows multimedia platform. Topology for supplying media data is generated using three kinds of pipeline components such as Media Source, Transform and Media Sink. The foregoing Media source is a component, which mainly handles input data and generates media data. The foregoing Transform is a component such as a decoder, which is an intermediate component for processing media data. The foregoing Media Sink is a component such as a renderer, which outputs media data.

DVD-Video data reproduced by the DVD drive 112 is supplied to a DVD navigation 501. The DVD-Video data is coded by a content scramble system (CSS). The navigation 501 decodes the coded data to separate a video pack (V_PCK), a sub-picture pack (SP_PCK) and an audio pack (A_PCK) from the decoded data. Then, the navigation 501 supplies the audio pack (A_PCK) to an audio decoder 511. Further, the navigation 501 supplies the foregoing video pack (V_PCK) and sub-picture pack (SP_PCK) to a video decoder 521 and a sub-picture decoder 541 respectively.

In this case, the DVD-Video is stored with 30 FPS interlaced motion picture data. When a DVD is reproduced and a motion picture image is displayed on the display panel 17, a frame image is generated from neighboring field images, and thereby, 60 FPS progressive motion pictures are displayed on the display panel 17.

The audio decoder decompresses compressed and coded audio information to convert it into non-compression audio data, and then, supplies the audio data to an audio rate converter 512. The audio rate converter 512 converts the audio data into a suitable sampling rate, and thereafter, supplies it to a sound renderer 513. The sound renderer 513 synthesizes the supplied audio data and audio data generated by other software operating on the computer, and then, supplies the synthesized audio data to an audio driver 514. The audio driver 514 controls the audio controller 106 so that audio is output from speakers 18A and 18B.

In the video decoder 521, if line 21 data is included, the video decoder 521 supplies the line 21 data to a line 21 decoder 522. The video decoder 521 decodes a video pack (V_PCK) to generate a field image. The sub-picture decoder 541 decodes a sub-picture pack (SP_PCK). The decoded data is supplied to an Enhanced Video Renderer 523.

A mixer 523A of the Enhanced video renderer 523 executes interlaced/progressive (I/P) conversion with respect to a plurality of frames supplied from the video decoder 521. In this way, the mixer 523A generates a frame image (video data) from the field image. The generated frame image is supplied to a presenter 523B.

The presenter 523B executes the following processing; namely, it synthesizes a sub-picture and a closed caption into a frame image and renders a frame. Color representation of each pixel in a rendered frame image is performed by means of a RGB colorimetric system. The RGB colorimetric system represents colors by additive mixture of colors in the reference color, that is, red, green and blue. For example, red, green and blue in a pixel is expressed by a bit value (0x00 to 0xFF) having an 8-bit length. The bit value denotes brightness.

Moreover, the presenter 523B corrects a bit value showing a red brightness, a bit value showing a green brightness and a bit value showing a blue brightness in each pixel of a rendered frame image based on a gamma correction table described later. Further, the presenter 523B adjusts contrast, hue, saturation and brightness of a corrected frame image based on adjustment data.

Moving image data output from the presenter 523B is supplied to a display driver 524. The display driver 524 controls the GPU 105 so that a moving image is displayed on the display panel 17.

A player shell/user interface 531 displays and maintains a playback control panel. Moreover, the player shell/user interface 531 notifies a command corresponding to a button operated by user to Media Foundation 510 by way of a graphic manager/media foundation player 532. Media Foundation 510 controls a topology formed of navigation 501, audio decoder 511 and video decoder 521 in accordance with the notified command.

A management unit 533 selects one mode setting data from mode setting data 300 having a plurality of mode setting data, and then, notifies the selected mode setting data to the presenter 523B. In this case, the mode setting data 300 is stored in the HDD 111.

The presenter 523B stores the mode setting data notified from the management unit 533 in a register 523C. Then, the presenter 523B refers to mode setting data stored in the register 523C to perform gamma correction and to adjust an image quality such as contrast, hue, saturation and brightness. In this case, the register 523C is set in the main memory 103.

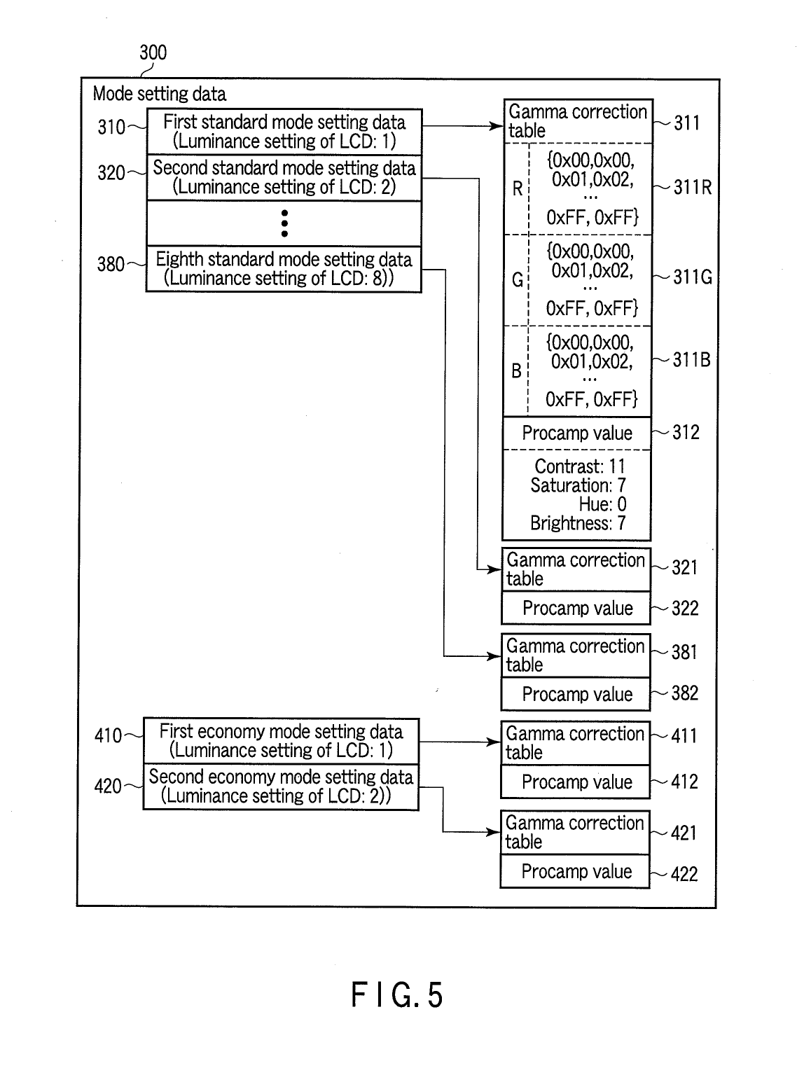

The configuration of the foregoing mode setting data 300 will be described below with reference to FIG. 5. The mode setting data 300 includes a first standard mode setting data 310, a second standard mode setting data 320, . . . , an eighth standard mode setting data 380, a first economy mode setting data 410 and a second economy mode setting data 420. Any of the foregoing first to eighth standard mode setting data 310 to 380 is loaded into the register 523C when the computer is driven by external power. Moreover, the foregoing first standard mode setting data 310 is set when the luminance level of the backlight 172 is “1”. The foregoing second standard mode setting data 320 is set when the luminance level of the backlight 172 is “2”. The foregoing eighth standard mode setting data 380 is set when the luminance level of the backlight 172 is “8”. If the computer is driven by internal power (battery) and not external power, any of the first to eighth standard mode setting data 310 to 380 is loaded into the register 523C.

The foregoing first or second economy mode setting data 410 or 420 is loaded into the register 523C when the computer is driven by a battery. Moreover, the first economy mode setting data 410 is set when the luminance level of the backlight 172 is “1” while the second economy mode setting data 420 is set when the luminance level of the backlight 172 is “2”. In other words, the foregoing economy mode setting data are prepared for the cases where the luminance level of the backlight 172 is less than 3.

The management unit 533 selects any of the first to eighth standard mode setting data 310 to 380 when the computer is driven by external power. Then, the management unit 533 notifies the selected standard mode setting data to the presenter 523B.

Moreover, when the computer is driven by a battery and a value recorded in a mode setter 534 shows that an economy mode is effective, the management unit 533 executes the following processing. Namely, the management unit 533 selects any of the first and second economy mode setting data 410 and 420, and then, notifies the selected economy mode setting data to the presenter 523B. Conversely, when the computer is driven by a battery and a value recorded in a mode setter 534 shows that an economy mode is not effective, the management unit 533 executes the following processing. Namely, the management unit 533 selects any of the first to eighth standard mode setting data 310 to 380, and then, notifies the selected standard mode setting data to the presenter 523B. In this case, user is able to change the value of the mode setter 534 by setup from the DVD application 202.

As can be seen from FIG. 5, mode setting data 310, 320, 410 and 420 has gamma correction tables 311, 321, 411 and 421 and processing amplifier (ProcAmp) values 312, 322, 412 and 422, respectively.

For example, the gamma correction table 311 includes red, green and blue correction data 311R, 311G and 311B. The red correction data 311R shows a corrected red bit value set with respect to a red bit value. The green correction data 311G shows a corrected green bit value set with respect to a green bit value. The blue correction data 311B shows a corrected blue bit value set with respect to a blue bit value.

For example, {0x00, 0x00, 0x01, 0x02, 0x02, . . , 0xFF, 0xFF} is described in the red correction data 311R. The first two digits (0x00, 0x00) show a red correction value (0x00) for correcting a red bit value (0x00) before correction. The next two digits (0x01, 0x02) show a red correction value (0x02) for correcting a red bit value (0x01) before correction. The final two digits (0xFF, 0xFF) show a red correction value (0xFF) for correcting a red bit value (0xFF) before correction. The foregoing data 311G and 311B each have the same structure as the data 311R. Gamma correction tables 321, 381, 411 and 421 each include data having the same structure as data 311R, 311G and 311B.

In the backlight 172 used for a personal computer, the color temperature changes according to a luminance; for this reason, there is a need to use a gamma correction value different between each color of RGB. In view of the foregoing circumstances, color measurement of the display panel 17 with respect to each bit value of each color is previously made. In this way, the optimum correction bit value for each color is prepared in a gamma correction table.

A contrast adjustment value (11), a saturation adjustment value (7), a hue adjustment value (0) and a brightness adjustment value (7) are described in a ProcAmp value 312. The luminance is increased using gamma correction, and thereafter, there is the case where the whole image is seen whitish; for this reason, colorfulness is lost. The image quality is adjusted with respect to a gamma-corrected frame image based on a prepared ProcAmp value; in this way, the color is vividly and beautifully expressed.

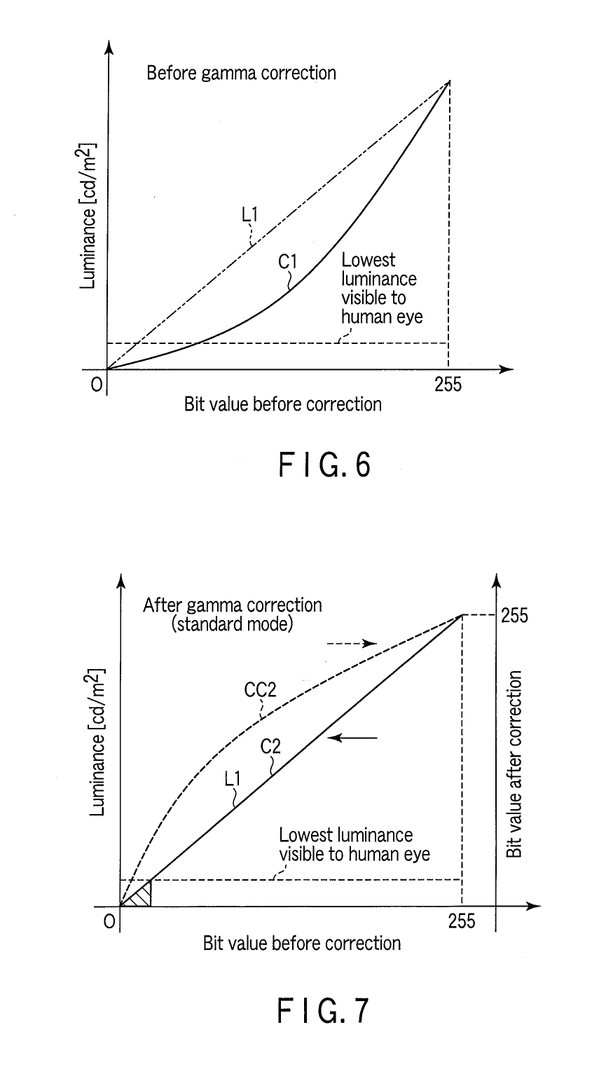

FIG. 6 is a graph showing a luminance displayed on the display panel 17 with respect to a bit value before gamma correction. In the graph of FIG. 6 the horizontal axis represents bit value before correction, and the vertical axis represents luminance. In this case, a bit value discretely changes; however, assuming that the bit value continuously changes, a luminance with respect to a bit value is shown by an approximate curve. FIG. 6 shows a luminance displayed on the display panel 17 with respect to a bit value showing a red brightness. The following description is established in a luminance displayed on the display panel 17 with respect to a bit value showing a green brightness and in a luminance displayed on the display panel 17 with respect to a bit value showing a blue brightness.

A bit value-luminance curve C1 shown in FIG. 6 is an approximate curve with respect to a bit value, which is not gamma-corrected. Moreover, a straight line L1 shown in the graph of FIG. 6 is a segment, which connects the origin O of the graph and a luminance with respect to the maximum value of a bit value.

As shown in FIG. 6, bit value-luminance curve C1 is expressed by a quadratic function curve. In order to accurately display moving image data stored in a Digital Versatile Disk (DVD) on the display panel 17, a luminance with respect to an uncorrected bit value must be placed on straight line L1. However, as can be seen from FIG. 6, bit value-luminance curve C1 is not overlapped with straight line L1 in a range excluding the minimum and maximum values of a bit value.

FIG. 7 is a graph showing a luminance of the display panel 17 corresponding to a bit value corrected by a gamma correction table 311 included in a first standard mode setting data 310 with respect to a bit value before correction. In this case, FIG. 7 shows a luminance of the display panel 17 corresponding to a red bit value corrected by the gamma correction table 311 with respect to a red bit value before correction. The following description is established in a green bit value corrected by the gamma correction table 311 with respect to a green bit value before correction and in a blue bit value corrected by the gamma correction table 311 with respect to a blue bit value before correction.

In the graph of FIG. 7, the horizontal axis represents bit value before correction, the left-hand vertical axis represents luminance, and the right-hand vertical axis represents bit value after correction.

A bit value-luminance curve C2 shown in FIG. 7 is an approximate straight line showing a luminance corresponding to a bit value after correction with respect to a bit value, which is not gamma-corrected. In the graph of FIG. 7, a straight line L1 is a segment, which connects the origin O of the graph and a luminance corresponding to the maximum value of a bit value. A correction curve CC2 shows a bit value after correction with respect to a bit value before correction.

As can be seen from FIG. 7, bit-value-luminance curve C2 is overlapped with straight line L1. As a result, moving image data stored on a DVD is accurately displayable on the display panel 17.

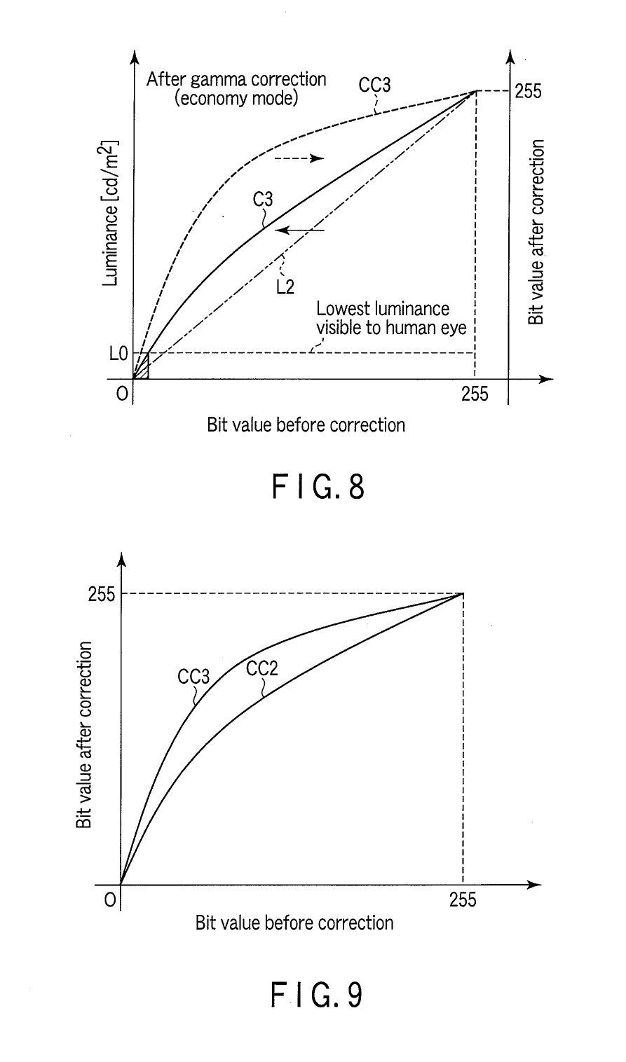

FIG. 8 is a graph showing a luminance of the display panel 17 corresponding to a bit value corrected by a gamma correction table 411 included in a first economy mode setting data 410 with respect to a bit value before correction. In this case, FIG. 8 shows a luminance of the display panel 17 corresponding to a red bit value corrected by the gamma correction table 411 with respect to a red bit value before correction. The following description is established in a green bit value corrected by the gamma correction table 411 with respect to a green bit value before correction and in a blue bit value corrected by the gamma correction table 411 with respect to a blue bit value before correction.

In the graph of FIG. 8, the horizontal axis represents bit value before correction, the left-hand vertical axis represents luminance, and the right-hand vertical axis represents bit value after correction.

A bit value-luminance curve C3 shown in FIG. 8 is an approximate curve showing a luminance corresponding to a bit value after correction with respect to a bit value, which is not gamma-corrected. In the graph of FIG. 8, a straight line L2 is a segment, which connects the origin O of the graph and a luminance corresponding to the maximum value of a bit value. A correction curve CC3 shows a bit value after correction with respect to a bit value before correction.

In a range excluding the minimum and maximum bit values before correction, bit value-luminance curve C3 exists in an area above straight line L2. In other words, a luminance with respect to a red bit value excluding the minimum and maximum bit values before correction is designed to be situated on an area above segment L2 connecting the origin of the foregoing (first) graph and a luminance with respect to a red bit value showing the maximum brightness.

However, luminance range lower than the lowest luminance L0 visible to the human eye is not visible to the human eye. Therefore, a luminance with respect to a red bit value excluding the minimum bit value before correction at the foregoing luminance range can also be designed to situate on an area below segment L2.

FIG. 9 is a graph showing a bit value corrected by the gamma correction table 311 included in the first standard mode setting data 310 and a bit value corrected by the gamma correction table 411 included in the first economy mode setting data 410 with respect to a bit value before correction. As can be seen from FIG. 9, in a range excluding the uppermost and lowermost bit values before correction, approximate curve CC3 showing a bit value corrected by the gamma correction table 411 exists above approximate curve CC2 showing a bit value corrected by the gamma correction table 311. In other words, the bit value (brightness) corrected by the gamma correction table 411 shows a bit value (brightness) higher than the bit value (brightness) corrected by the gamma correction table 311.

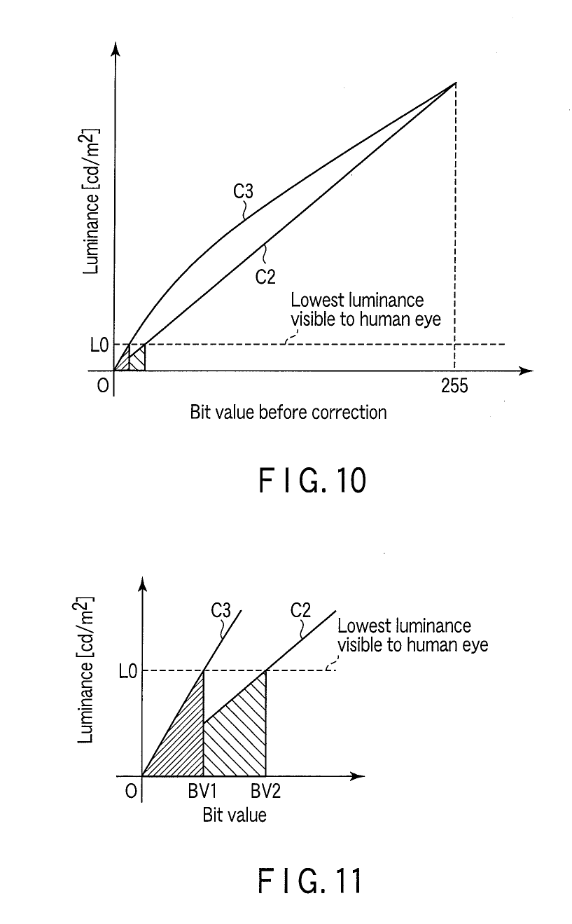

FIG. 10 is a graph showing the bit value-luminance curves C2 and C3 on the same coordinate. As can be seen from FIG. 10, bit value-luminance curve C3 is situated above bit value-luminance curve C2 in a range excluding the minimum and maximum bit values of a bit value. In other words, correction is made by the gamma correction table 411 included in the first economy mode setting data 410, and thereby, brighter display is produced compared with the case where correction is made by the gamma correction table 311 included in the standard mode setting data 310. As a result, a portion, which is not visible in correction by the gamma correction table 311 included in the standard mode setting data 310, is corrected by the gamma correction table 411 included in the first economy mode setting data 410, and thereby, there is the case where the portion becomes visible.

FIG. 11 is a graph enlarging a low bit value area shown in the graph of FIG. 10. As shown in FIG. 11, a bit value BV1 showing the intersection of the lowest luminance L0 and bit value-luminance curve C3 is lower than a bit value VB2 showing the lowest luminance L0 and bit value-luminance curve C2. Therefore, correction is made by the gamma correction table 411 of the first economy mode setting data 410, and thereby, a range visible to the human eye becomes wider than the case where correction is made by the gamma correction table 311 of the standard mode setting data 310.

Thus, this means the following advantages. Namely, when the luminance of the backlight 172 is reduced, an invisible scene exists even if correction is made by the gamma correction table 311 of the standard mode setting data 310. However, when correction is made by the gamma correction table 411 of the first economy mode setting data 410, the foregoing scene is visible.

The following technique has been described before. According to the technique, in order to convert the luminance of a frame image, the frame image is converted from a RGB format into a YCbCr format. Thereafter, a luminance component signal Y is adjusted, and thereafter, the frame image is converted from YCbCr format back into a RGB format. However, according to this embodiment, only simple correction of the luminance (brightness) of a pixel in the frame image is made. Namely, a reference of a gamma table is only made so that the original luminance bit value is replaced with a corrected bit value.

On the other hand, a correction table corresponding to the luminance level of the backlight 172 has red, green and blue correction data prepared every red, green and blue. Color measurement corresponding to a luminance level is carried out for each color, and thereby, the optimal correction data for each color is prepared. In accordance with the luminance level, correction data is prepared for each color, and thereby, this serves to prevent a generation of color shift.

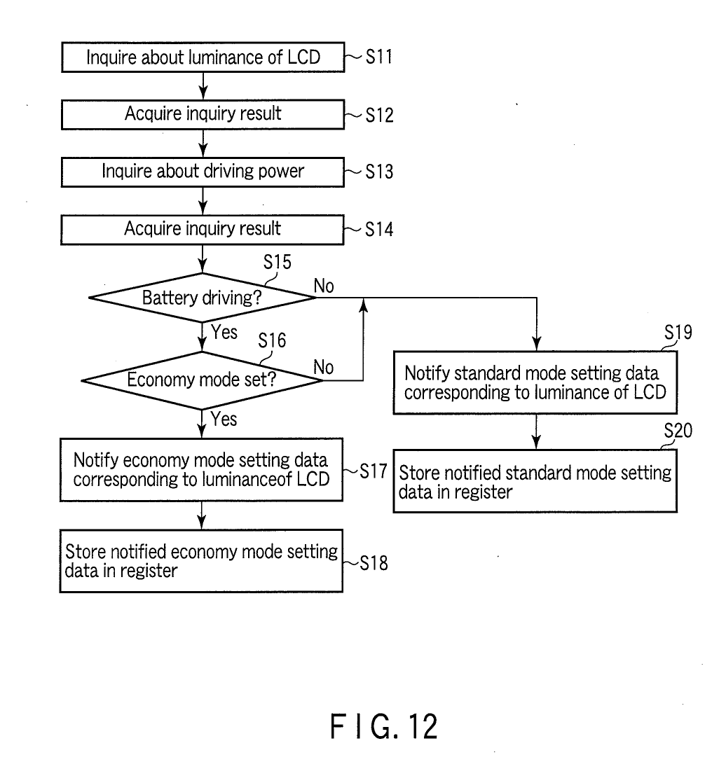

The procedure of notifying a mode to the presenter 523B by the management unit 533 will be described below with reference to a flowchart of FIG. 12. In this case, the procedure of notifying the mode is carried out when a DVD application program 202 starts.

First, the management unit 533 makes an inquiry about the luminance level of the backlight 172 from the operating system 201 (block S11). Then, the unit 533 acquires the inquiry result from the operating system 201 (block S12).

The management unit 533 makes an inquiry about a generation source of driving power of the computer 10 from the operating system 201 (block S13). Then, the unit 533 acquires the inquiry result from the operating system 201 (block S14). Based on the inquiry result, the unit 533 determines whether or not the computer 10 is driven by internal power (battery) (block S15).

If it is determined that the computer 10 is driven by internal power (Yes in block S15), the management unit 533 refers to a mode setter 534 to determine whether or not an economy mode is effective (block S16). If it is determined that the economy mode is effective (Yes in block S16), the unit 533 notifies economy mode setting data corresponding to the luminance level of the backlight 172 acquired in block S12 (block S17). The presenter 523B stores the economy mode setting data notified to the register 523C (block S18).

Conversely, if it is determined that the computer 10 is not driven by internal power (No in block S15) or that an economy mode is not effective (No in block S16), the management unit 533 notifies standard mode setting data corresponding to the luminance level of the backlight 172 acquired in block S12 (block S19). The presenter 523B stores the standard mode setting data notified to the register 523C (block S20).

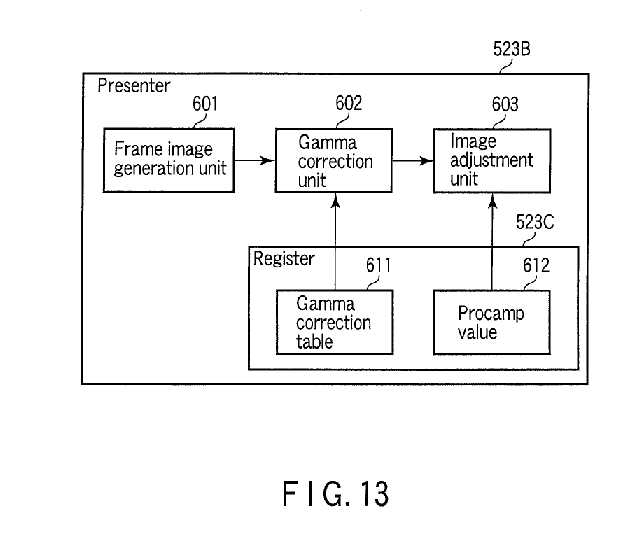

The configuration of the presenter 523B for executing generation, gamma correction and image quality adjustment of a frame image will be described below with reference to FIG. 13.

As shown in FIG. 13, the presenter 523B includes a frame image generation unit 601, a gamma correction unit 602 and an image quality adjustment unit 603. The frame image generation unit 601 generates a frame image from an image output from the mixer 523A and the line 21 decoder 522. The gamma correction unit 602 corrects the frame image generated by the frame image generation unit 601 based on a gamma correction table 611 stored in the register 523C. The gamma correction table 611 is a gamma correction table included in the mode setting data notified from the management unit 533 to the presenter 523B. The image quality adjustment unit 603 adjusts the image quality of a frame image gamma-corrected by the gamma correction unit 602 based on a ProcAmp value 612. The ProcAmp value 612 is included in the mode setting data notified from the management unit 533 to the presenter 523B.

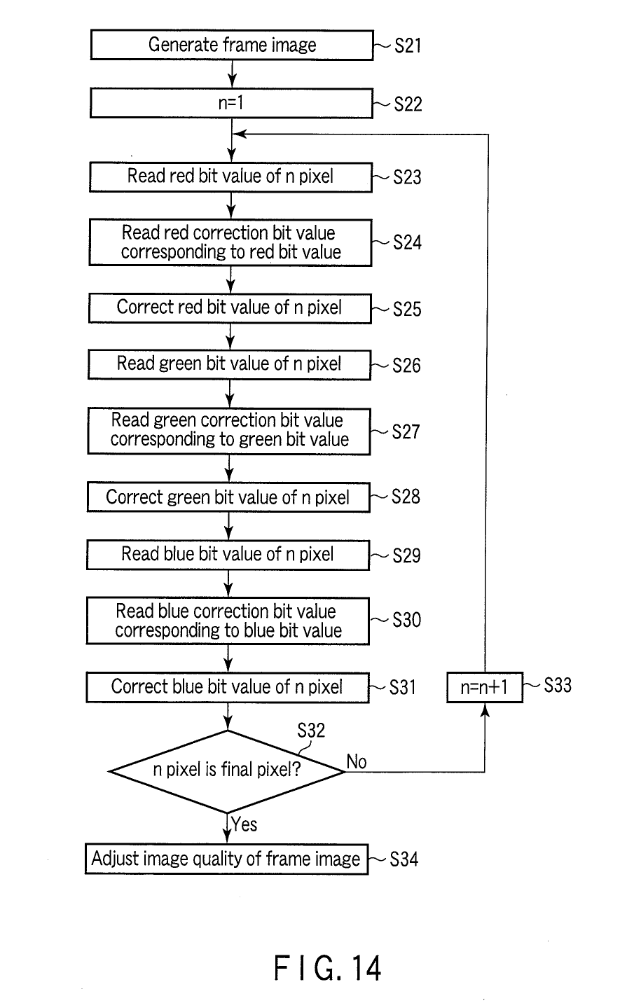

The procedure of executing a generation of a frame image, gamma correction and image quality adjustment will be described below with reference to a flowchart of FIG. 14. Hereinafter, gamma correction and image quality adjustment are executed using the gamma correction table 411 and the ProcAmp value 412.

First, the frame image generation unit 601 generates a frame image from an image output from the mixer 523A and the line 21 decoder 522 (block S21). Then, the gamma correction unit 602 sets data n to “1” (block S22).

The gamma correction unit 602 reads a red bit value of n pixel of a frame image (block S23). Then, the unit 602 reads a red correction bit value corresponding to the read red bit value from a red correction data (block S24). Thereafter, the unit 602 corrects a red bit value of n pixel of the frame image using the read red correction bit value (block S25).

Further, the gamma correction unit 602 reads a green bit value of n pixel of a frame image (block S26). Then, the unit 602 reads a green correction bit value corresponding to the read green bit value from a green correction data (block S27). Thereafter, the unit 602 corrects a green bit value of n pixel of the frame image using the read green correction bit value (block S28).

Further, the gamma correction unit 602 reads a blue bit value of n pixel of a frame image (block S29). Then, the unit 602 reads a blue correction bit value corresponding to the read blue bit value from a blue correction data (block S30). Thereafter, the unit 602 corrects a blue bit value of n pixel of the frame image using the read blue correction bit value (block S31).

The gamma correction unit 602 determines whether or not the foregoing n pixel is the final pixel of the frame image (block S32). If it is determined that the n pixel is not the final pixel (No in block S32), the unit 602 sets a value adding “1” to the value originally set to n as a new n value (block S33). The unit 602 executes the procedures from blocks S23 to S32. In block S32, if it is determined that the n pixel is the final pixel (Yes in block S32), gamma correction with respect to a frame image ends. Then, the image quality adjustment unit 603 adjusts the image quality of the frame image gamma-corrected by the gamma correction unit 602 using the ProcAmp value 412 (block S34).

The foregoing procedures are performed, and thereby, a generation of a frame image, gamma correction, gamma correction for adjusting an image quality of a frame image and an image quality adjustment are performed.

The foregoing embodiment relates to the case of referring to a table in which a correction bit value corresponding to a bit value is described, and thereby, correcting the bit value. In this case, a correction bit value corresponding to a bit value may be obtained from a prepared formula.

The method used in conjunction with the embodiment described above can be distributed as a computer program, recorded in a storage medium such as a magnetic disk (flexible disk, hard disk, etc.), an optical disk (CD-ROM, DVD, etc.), a magneto-optical disk (MO), or a semiconductor memory.

The storage medium can be of any storage scheme as long as it can store programs in such a way that computers can read the programs from it.

Further, the operating system (OS) working in a computer in accordance with the programs installed into the computer from a storage medium, or the middleware (MW) such as database management software and network software may perform a part of each process in the present embodiment.

Still further, the storage media used in the embodiment are not limited to the media independent of computers. Rather, they may be media storing or temporarily storing the programs transmitted via LAN or the Internet.

Moreover, for the embodiment, not only one storage medium, but two or more storage media may be used, in order to perform various processes in the embodiment. The storage media or media can be of any configuration.

The computer used in the embodiment performs various processes in the embodiment, on the basis of the programs stored in a storage medium or media. The computer may be a stand-alone computer such as a personal computer, or a computer incorporated in a system composed of network-connected apparatuses.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. A display apparatus comprising:
an uncorrected video data generator configured to generate uncorrected video data comprising a plurality of pixels each associated with a plurality of uncorrected brightness values corresponding to three or more reference colors;
a selection processor configured to select first correction data or second correction data,
the first correction data being associated with a luminance level corresponding to a normal mode, and
the second correction data being associated with a luminance level corresponding to an economy mode;
a correction processor configured to correct the uncorrected brightness values associated with each pixel of the uncorrected video data based on the selected correction data, and thereby produce corrected video data comprising a plurality of pixels each associated with a plurality of corrected brightness values; and
a video signal generator configured to generate a video signal based on the corrected video data;
a display panel configured to display a video image based on the video signal, and comprising a liquid crystal panel and a backlight configured to illuminate the liquid crystal panel based on the luminance level corresponding to the normal mode or the luminance level corresponding to the economy mode,
wherein the correction processor is configured to correct the uncorrected brightness values such that a first corrected brightness value obtained by correcting a first uncorrected brightness value based on the first correction data is lower than a second corrected brightness value obtained by correcting the first uncorrected brightness value based on the second correction data, and the first uncorrected brightness value is between a minimum brightness value and a maximum brightness value.

2. The apparatus of claim 1, wherein
the luminance level corresponding to the normal mode and the luminance level corresponding to the economy mode are the same.

3. The apparatus of claim 1, further comprising
an adjustment processor configured to adjust hue, saturation, contrast, and/or brightness of the corrected video data based on setting data corresponding to the selected correction data and comprising setting values of hue, saturation, contrast, and/or brightness.

4. The apparatus of claim 1, wherein
the display apparatus is configured to be powered by a battery and an external power supply, and
the selection processor is configured to select the second correction data when the display apparatus is powered by the battery, and to select the first correction data when the display apparatus is powered by the external power supply.

5. The apparatus of claim 1, wherein
the correction processor is configured to correct the uncorrected brightness values such that
a second uncorrected brightness value is different from the first uncorrected brightness value,
a third corrected brightness value is obtained by correcting the second uncorrected brightness value based on the first correction data, and
the display panel is configured to display a luminance based on the third corrected brightness value, which luminance is lower than the lowest luminance visible to human eye.

6. The apparatus of claim 1, wherein
brightness values are expressed by first bit values comprising a predetermined bit length,
the first correction data comprise second bit values for correcting the first bit values, and the second correction data comprises third bit values for correcting the first bit values.

7. A display apparatus comprising:
an uncorrected video data generator configured to generate uncorrected video data comprising a plurality of pixels each associated with a plurality of uncorrected brightness values corresponding to three or more reference colors;
a selection processor configured to select first correction data, associated with a luminance level corresponding to a normal mode, or second correction data, associated with a luminance level corresponding to a economy mode;
a correction processor configured to correct the brightness values associated with each pixel of the uncorrected video data based on the selected correction data;
a video signal generator configured to generate a video signal based on the corrected video data;
a display panel configured to display a video image based on the video signal, and comprising a liquid crystal panel and a backlight configured to illuminate the liquid crystal panel based on the luminance level corresponding to the normal mode or the luminance level corresponding to the economy mode,
wherein a first corrected brightness value obtained by correcting a first uncorrected brightness value based on the first correction data is lower than a second corrected brightness value obtained by correcting the first uncorrected brightness value based on the second correction data, and the first uncorrected brightness value is different from a low brightness value, a high brightness value, and a second uncorrected brightness value, and
wherein the display panel is configured to display a luminance based on a third corrected brightness value obtained by correcting the second uncorrected brightness value based on the first correction data, which luminance is lower than lowest luminance visible to human eye.

8. The apparatus of claim 7, wherein
the luminance level corresponding to the normal mode and the luminance level corresponding to the economy mode are same luminance level.

9. A display method used for a display apparatus, the display apparatus comprising a display panel configured to display a video image based on a video signal, the display panel comprising a liquid crystal panel and; and a backlight configured to illuminate the liquid crystal panel based on a luminance level, the method comprising:
generating uncorrected video data comprising a plurality of pixels each associated with a plurality of uncorrected brightness values corresponding to three or more reference colors;
selecting first correction data, which is associated with a luminance level corresponding to a normal mode, or second correction data, which is associated with a luminance level corresponding to a economy mode;
correcting the uncorrected brightness values of each pixel of the uncorrected video data based on the selected correction data, thereby producing corrected video data comprising a plurality of pixels each associated with a plurality of corrected brightness values; and
generating the video signal based on the corrected video data,
wherein a first corrected brightness value obtained by correcting a first uncorrected brightness value based on the first correction data is lower than a second corrected brightness value obtained by correcting the first uncorrected brightness value based on the second correction data, and the first uncorrected brightness value is between a minimum brightness value and a maximum brightness value.

10. The method of claim 9, wherein
the luminance level corresponding to the normal mode and the luminance level corresponding to the economy mode are a same luminance level.

11. The method of claim 9, further comprising:
adjusting an image quality of the corrected video data based on setting data corresponding to the selected correction data and comprising setting values of hue, saturation, contrast and/or brightness.

12. The method of claim 9, wherein the display apparatus is configured to be powered by a battery and by an external power supply, and
selecting the correction data comprises selecting the first correction data when the display unit is powered by the battery, and selecting the second correction data when the display unit is powered by the external power supply.

13. The method of claim 9, wherein
the first uncorrected brightness is different from a second uncorrected brightness value, and
the display apparatus is configured to display a luminance based on a third corrected brightness value obtained by correcting the second corrected brightness value based on the first correction data, which luminance is lower than the lowest luminance visible to human eye.

14. The method of claim 9, wherein the brightness values are expressed by first bit values comprising a predetermined bit length, and
the correction information comprises second bit values for correcting the first bit values.

15. A computer readable medium having stored thereon a program that, when executed by a computer comprising a display panel configured to display a video image based on a video signal, the display panel comprising liquid crystal panel and a backlight configured to illuminate the liquid crystal panel based on a luminance level, causes the computer to:
generate uncorrected video data comprising a plurality of pixels each associated with a plurality of uncorrected brightness values corresponding to three or more reference colors;
select first correction data, associated with a luminance level of the backlight corresponding to a normal mode, or second correction data, associated with a luminance level corresponding to a economy mode;
correct the brightness values of each pixel of the uncorrected video data based on the selected correction data, and thereby produce corrected video data comprising a plurality of pixels each associated with a plurality of corrected brightness values; and
generate the video signal based on the corrected video data,
wherein a first corrected brightness value obtained by correcting a first uncorrected brightness value based on the first correction data is lower than a second uncorrected brightness value obtained by correcting the first uncorrected brightness value based on the second correction data, and the first uncorrected brightness value is between a minimum brightness value and a maximum brightness value.
